(19) United States
(12) Patent Application Publication
(10) Pub. No.: US 2020/0095133 A1
(43) Pub. Date: Mar. 26, 2020

(54) Treatment Method and Treatment Apparatus for Uranium Hexaflouride Residue Within Cylinder, Using Gas Phase Reaction

(71) Applicants: Youngmoon Bae, Daejeon (KR); Yudon Moon, Daejeon (KR); In-Kyu Hwang, Daejeon (KR); Hyundong Shin, Daejeon (KR); Seungchul Yang, Daejeon (KR); Dongyong Kwak, Daejeon (KR); Byungkook Lee, Sejong (KR); Hyunkwang Cho, Daejeon (KR); Junho Lee, Daejeon (KR)

(72) Inventors: Youngmoon Bae, Daejeon (KR); Yudon Moon, Daejeon (KR); In-Kyu Hwang, Daejeon (KR); Hyundong Shin, Daejeon (KR); Seungchul Yang, Daejeon (KR); Dongyong Kwak, Daejeon (KR); Byungkook Lee, Sejong (KR); Hyunkwang Cho, Daejeon (KR); Junho Lee, Daejeon (KR)

(73) Assignee: KEPCO NUCLEAR FUEL CO., LTD., Daejeon (KR)

(21) Appl. No.: 16/695,979

(22) Filed: Nov. 26, 2019

Related U.S. Application Data
(63) Continuation of application No. PCT/KR2017/014802, filed on Dec. 15, 2017.

(30) Foreign Application Priority Data
Jun. 1, 2017 (KR) 10-2017-0068544

(51) Int. Cl. C01G 43/025; C01G 43/06; G21C 3/62

(52) U.S. Cl. CPC C01G 43/025; G21C 3/623; C01G 43/063

(57) ABSTRACT

Embodiments of the disclosure relate to a treatment method and a treatment apparatus for a UF₆ heel, using a gas phase reaction. A specific treatment method includes (1) vaporizing the UF₆ heel, (2) manufacturing solid phase UO₂F₂ by using UF₆ gas vaporized at step (1), (3) separating the solid phase UO₂F₂ and by-product gas from each other, and (4) separating hydrogen fluoride from the by-product gas. According to the disclosure, stabilization of a reconversion process and the quality of UO₂ powder may be improved by manufacturing the solid phase UO₂F₂, which is an intermediate of the UO₂ powder, through the UF₆ heel treatment, and the high cost of radioactive waste disposal is reduced by minimizing the UF₆ heel to be less than 0.5 kg.

### CROSS-REFERENCE TO RELATED PATENT APPLICATIONS

This patent application is a continuation of PCT/KR2017/014802, filed Dec. 15, 2017, which claims priority to Korean Patent Application No. 10-2017-0068544, filed Jun. 1, 2017, the entire teachings and disclosure of which are incorporated herein by reference thereto.

### FIELD

The present invention relates to a treatment method and a treatment apparatus for residues (hereinafter referred to as “UF₆ heel”) remaining inside a cylinder after vaporization of uranium hexafluoride (hereinafter referred to as “UF₆”) and, more particularly, to a treatment method and a treatment apparatus for the UF₆ heel that manufacture solid uranyl fluoride (hereinafter referred to as “UO₂F₂”), which is an intermediate of uranium dioxide (hereinafter referred to as “UO₂”) powder manufacture, using a gas phase reaction and supply the UO₂F₂ to a reconversion process through a separate treatment apparatus for the UF₆ heel, separated from the vaporization process of the reconversion process.

### BACKGROUND

When manufacturing nuclear fuel for light water reactors, UF₆ is first manufactured as a solid phase UO₂ powder through a reconversion process, and then processed into a pressed green pellet through a homogeneous mixing and powder preparation process. The pressed green pellet is sintered and ground to complete a UO₂ sintered body. The UO₂ sintered body is charged into a fuel rod and completed as a nuclear fuel assembly through end cap welding, skeletal assembly, lacquer coating, assembly fabrication, helium leak testing, and the like. In the reconversion process, which is a core process at this time, the recovery of uranium through UF₆ heel treatment after UF₆ vaporization is essential. This is because the UF₆ heel treatment is a method of reducing an amount of radioactive waste, which is expensive to process, and is a desirable process to increase a uranium recovery rate and enhance economic efficiency of a nuclear fuel manufacturing process.

The UF₆, which is a raw material for the nuclear fuel of the light water reactors, exists in a solid phase at room temperature, and, as vapor pressure thereof is low, is difficult to be supplied to the reactor by a desired amount. The UF₆ has a triple point of 64.4° C. at about 1.5 barg and vaporizes easily at temperatures no less than the triple point. Therefore, in order to supply the UF₆ into UO₂ conversion furnace in a reconversion process, the UF₆ is to be heated to no less than the triple point. In a conventional reconversion process, temperature of a vaporizer is maintained at about 100° C. and equilibrium state of gas and liquid is made. Then only a gas phase UF₆ is separated and used.

As shown in FIG. 1, a cold trap is used in a conventional reconversion process. In the vaporizer, when the process pressure is lowered as most of the UF₆ inside the cylinder is extracted, and a supply flow rate of UF₆ falls equal to or below a predetermined limit, the UF₆ heel is extracted by switching to the cold trap facility. In addition, when the UF₆ heel of about 10 cylinders is recovered and the UF₆ inside the cold trap reaches an amount at least equal to a predetermined limit, work is performed in the same manner as in the vaporization process, and the gas phase UF₆ is supplied to the UO₂ conversion furnace in the reconversion process.

However, the UF₆ heel treatment using the conventional cold trap accompanies undesirable UO₂ powder quality evaluation and a step of UO₂ powder recycling, due to unstable process pressure and the like, whereby productivity is lowered. In addition, extraction efficiency of the UF₆ heel is also not good, whereby a large amount of radioactive waste is generated. This is because the UF₆ heel, which is not extracted even by a cold trap, is precipitated and stored as sodium biuranate scrap and the like through a separate UF₆ cylinder cleaning process.

Even overseas, the UF₆ heel treatment using the cold trap has been changing to a method using a vacuum pump for extraction of the UF₆ heel due to the above-mentioned problems and safety problems. Therefore, there is a need for a method and a preferred treatment apparatus for the UF₆heel, which not only improve the quality of UO₂ powder by efficiently operating the reconversion process, which is a key process for the manufacture of nuclear fuel for the light water reactors but also recover the uranium inside the UF₆cylinder to the maximum, thereby minimizing the UF₆ heel to less than 0.5 kg.

### BRIEF SUMMARY

Accordingly, the present invention has been made keeping in mind the above problems occurring in the related art, and an objective of the present invention is to provide a treatment method and a treatment apparatus preferable for uranium that can improve quality of UO₂ powder by stably and efficiently operating a reconversion process, which is a core process in the manufacture of nuclear fuel for a light water reactor, and can minimize an amount of a UF₆ heel to be less than 0.5 kg, thereby reducing a generation amount of radioactive waste being expensive to process.

In order to achieve the above objective according to one aspect of the present invention, there is provided a treatment method for a UF₆ heel, the treatment method including: (1) vaporizing the UF₆ heel; (2) manufacturing solid phase UO₂F₂ using UF₆ gas vaporized at step 1; (3) separating the solid phase UO₂F₂ and by-product gas from each other; and (4) separating hydrogen fluoride from the by-product gas.

The vaporizing the UF₆ heel at step 1 may supply an inert gas to vaporize the UF₆ and raise temperature to no less than a triple point of the UF₆.

The separating hydrogen fluoride from the by-product gas at step 4 may separate aqueous solution of hydrogen fluoride at a lower portion of a liquid/gas separator.

According to one embodiment of the present invention, there is provided a treatment apparatus for the UF₆ heel, the treatment apparatus including: a vaporizer for vaporizing the UF₆ heel; a reactor producing solid phase UO₂F₂ using UF₆ gas produced in the vaporizer by being connected with the vaporizer; a solid/gas separator separating the solid phase UO₂F₂ produced in the reactor from by-product gas by being connected with the reactor; a heat exchanger allowing the by-product gas supplied from the solid/gas separator to be passed and liquefying a portion of the gas by being connected with the solid/gas separator; and a liquid/gas separator separating liquid and gas, produced passing through the heater, from each other.

At least one gas phase distributor may be provided at the inside of the reactor for uniformly supplying the gas.

In order to manufacture the solid phase UO₂F₂ in the reactor, at least one of an inert gas and superheated steam may be supplied.

A fan may be provided by being connected to a side above the liquid/gas separator and may be configured to discharge at least a portion of the gas produced inside the liquid/gas separator.

Flow velocity inside the reactor may be controlled to be higher than minimum fluidization velocity of UO₂F₂ powder.

Flow velocity inside the solid/gas separator may be controlled to be lower than minimum fluidization velocity of UO₂F₂ powder.

According to the present invention as described above, the solid phase UO₂F₂, an intermediate of UO₂ powder, is manufactured with a separate process for the UF₆ heel treatment, thereby improving the quality of UO₂ powder and stability of the manufacturing process, and the UF₆ heel inside the UF₆ cylinder is minimized to be less than 0.5 kg, thereby reducing a generation amount of radioactive waste being expensive to process. Accordingly, preferable effects can be realized.

### BRIEF DESCRIPTION OF THE DRAWINGS

FIG. 1 shows a treatment method for a UF₆ heel using a conventional cold trap;

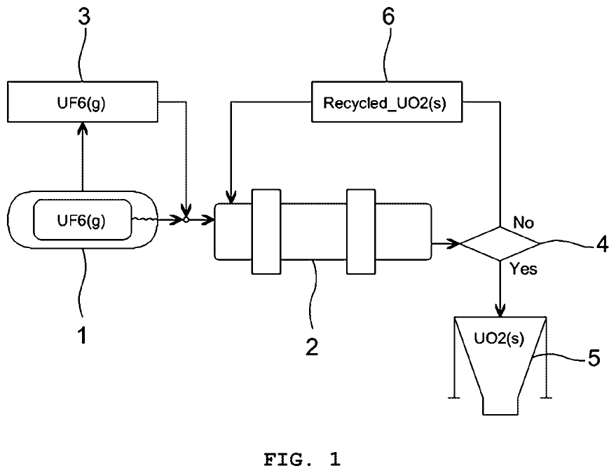

FIG. 2 shows a reconversion process of the present invention;

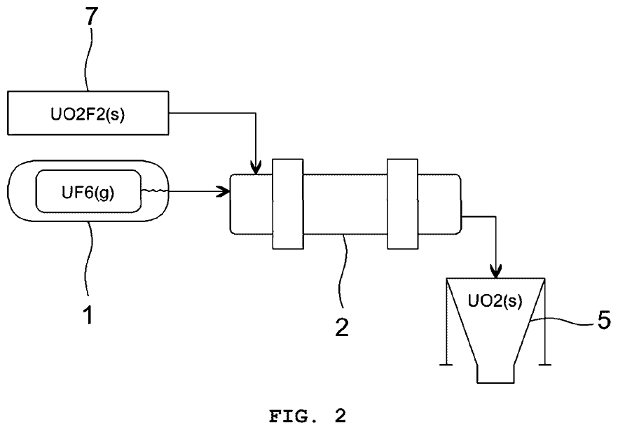

FIG. 3 shows a method and a treatment apparatus for the UF₆ heel of the present invention; and

FIG. 4 shows a UO₂F₂ reactor of the present invention.

### DETAILED DESCRIPTION

Hereinbelow, exemplary embodiments of the present invention will be described in detail.

There is provided a treatment method for a UF₆heel according to an embodiment of the present invention, the method including: (1) vaporizing the UF₆ heel; (2) manufacturing solid phase UO₂F₂ using UF₆ gas vaporized at step 1; (3) separating the solid phase UO₂F₂ and by-product gas from each other; and (4) separating hydrogen fluoride from the by-product gas above.

First, after vaporization of the UF₆ inside a cylinder, to extract the UF₆ heel, the temperature may be raised to no less than a triple point of the UF₆ or, in some cases, pressure may be boosted by supplying an inert gas. Here, the inert gas includes, but is not limited to, nitrogen gas. In addition, extraction of the UF₆ heel may be repeated according to an operation method for process of the UF₆ heel treatment.

In a process of supplying the UF₆ gas obtained by the above method to the reactor 72 manufacturing the UO₂F₂, depending on an amount of the UF₆ gas, the inert gas and superheated steam are supplied at an appropriate ratio. Thus, the solid phase UO₂F₂ may be obtained using the gases supplied together as raw material according to reaction formula 1 below. Some of the solid phase UO₂F₂ manufactured at this time may be discharged to a side below the reactor 72.

UF₆(g)+(2+×)H₂O(g)+N₂(g)→UO₂F₂ (s)+4HF(g)+xH₂O(g)+N₂(g) <Reaction formula 1>

The solid phase UO₂F₂ and the by-product gas, obtained from the UO₂F₂ reactor 72, are supplied to the solid/gas separator 73 so as to be separated from each other. Most of the solid phase UO₂F₂ is discharged to a side below the solid/gas separator 73, and the discharged UO₂F₂ is supplied to the UO₂ conversion furnace 2 together with some of the solid phase UO₂F₂ having been manufactured in and discharged from the UO₂F₂ reactor 72.

While passing through a heat exchanger 741, a portion of the by-product gas separated from the solid/gas separator 73 may be condensed. Then the separated by-product gas is supplied to the liquid/gas separator 74, whereby gas, mostly nitrogen gas, in an upper portion may be discharged by a fan 742, and the aqueous solution of hydrogen fluoride separated in a lower portion may be transferred by a pump 743.

A treatment apparatus for the UF₆ heel may include a vaporizer 71 used only for the UF₆ heel for vaporizing the UF₆ heel, a reactor 72 connected to the vaporizer 71 so as to manufacture the solid phase UO₂F₂ by using the UF₆ gas generated at the vaporizer 71, a solid/gas separator 73 connected to the reactor 72 so as to separate the solid phase UO₂ F₂which is manufactured in the reactor 72, from by-product gas, a heat exchanger 741 connected to the solid/gas separator 73 so as to allow the by-product gas, which is supplied from the solid/gas separator 73, to pass therethrough and be condensed into liquid, and a liquid/gas separator 74 configured to separate the hydrogen fluoride liquid, which is condensed at the heat exchanger 741, from the gas.

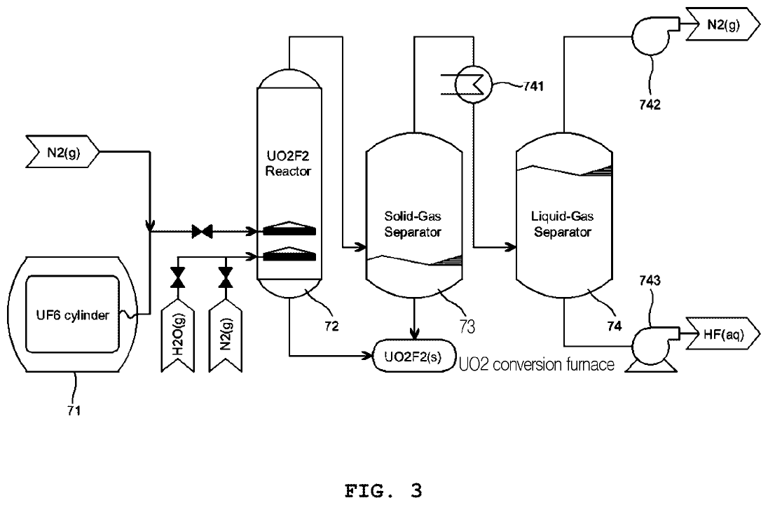

As shown in FIG. 3, in the treatment apparatus for the UF₆ heel, which is independent of the reconversion process, the pressure inside the UF₆ cylinder may be boosted by supplying the inert gas to the inside of the UF₆ cylinder according to the above-mentioned treatment method by using the vaporizer 71 used only for the UF₆ heel. Alternatively, a separate device may be provided to vaporize the UF₆ heel by raising the temperature of the UF₆ heel to no less than the triple point.

The UF₆ gas generated in the vaporizer 71 used only for the UF₆ heel is supplied, together with the superheated steam and the inert gas containing a desired ratio of nitrogen, to the UO₂F₂ reactor 72 that manufactures the solid phase UO₂F₂. In this case, the UO₂F₂ reactor 72 may include a measuring instrument 721 and control valves 722A, 722B, and 722C as necessary, and a supply amount of the UF₆gas may be adjusted by the provided measuring instrument 721 and control valve 722A. In addition, the superheated steam is controlled by the superheated steam control valve 722B, and the nitrogen gas is controlled by the nitrogen gas control valve 722C.

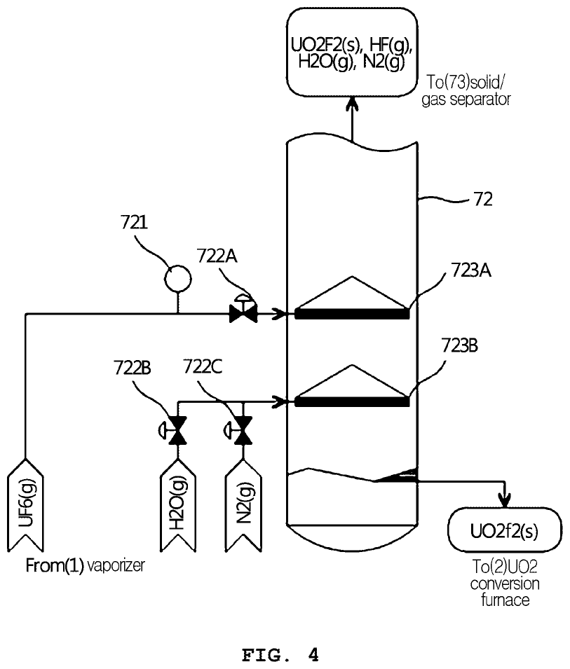

In the UO₂F₂ reactor 72, shown in detail in FIG. 4, by a gas phase distributor 723A of the UF₆ gas for uniformly supplying the UF₆ gas and a distributor 723B of the nitrogen gas or the superheated vapor, the solid phase UO₂F₂ is manufactured according to reaction formula 1. Some of the resulting solid phase UO₂F₂ may be discharged to a side below the UO₂F₂ reactor 72, but flow velocity inside the UO₂F₂ reactor 72 may be controlled to be higher than minimum fluidization velocity of the UO₂F₂ powder in order to allow the solid phase UO₂F₂ to be discharged to a side above the UO₂F₂ reactor 72.

The solid phase UO₂F₂ and by-product gas discharged from the upper portion of the UO₂F₂ reactor 72 are supplied to the solid/gas separator 73 so as to be respectively separated from each other. Here, most of the solid phase UO₂F₂ is discharged to the side below the solid/gas separator 73. In order to facilitate the solid phase UO₂F₂ to be discharged as above, flow velocity inside the solid/gas separator 73 is controlled to be lower than the minimum fluidization velocity of the UO₂F₂ powder. The solid phase UO₂F₂ thus separated is supplied to the UO₂ conversion furnace 2 together with the solid phase UO₂F₂ discharged from the side below the previous UO₂F₂ reactor 72. In this case, a shape of the solid/gas separator 73 is not limited, and apparatus conditions are to be set so that the by-product gas does not condense inside the solid/gas separator 73.

The liquid/gas separator 74 may include a heat exchanger 741 at a front end, a fan 742 at a rear end thereabove, and a pump 743 at a rear end therebelow, wherein the by-product gas discharged from the solid/gas separator 73 may pass through the heat exchanger 741 and condense into an aqueous solution of low concentration hydrogen fluoride. Then condensed aqueous solution and the by-product gas are supplied to the liquid/gas separator 74 so as to be separated from each other. Subsequently, the aqueous solution of low concentration hydrogen fluoride may be separated at the lower portion of the liquid/gas separator 74, and the aqueous solution of low concentration hydrogen fluoride thus separated is processed by the pump 743 connected to the liquid/gas separator 74. The by-product gas from which hydrogen fluoride has been removed may be composed of mostly nitrogen gas and is discharged by the fan 742 connected to the side above the liquid/gas separator 74. The fan 742 connected to the side above the liquid/gas separator 74 may contribute to play a role in maintaining most of the process of the present invention at an appropriate negative pressure and preventing the radioactive material from leaking to the outside.

The present invention described above is not limited to the above-described embodiment and the accompanying drawings, and those skilled in the art will appreciate that various substitutions, alterations, and modifications are possible, without departing from the scope and spirit of the invention as disclosed in the accompanying claims.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A treatment method for a UF₆ heel, the treatment method comprising:
(1) vaporizing the UF₆ heel;
(2) manufacturing solid phase UO₂F₂ using UF₆ gas vaporized at step (1);
(3) separating the solid phase UO₂F₂ and by-product gas from each other; and
(4) separating hydrogen fluoride from the by-product gas at step (4).

2. The treatment method of claim 1, wherein the vaporizing the UF₆ heel at step (1) further comprises supplying an inert gas to vaporize the UF₆ and raises the temperature to no less than a triple point of the UF₆.

3. The treatment method of claim 1, wherein the separating hydrogen fluoride from the by-product gas at step (4) further comprises separating aqueous solution of hydrogen fluoride at a lower portion of a liquid/gas separator.

4. A treatment apparatus for a UF₆ heel, the treatment apparatus comprising:
a vaporizer for vaporizing the UF₆ heel;
a reactor connected to the vaporizer so as to manufacture the solid phase UO₂F₂ by using the UF₆ gas generated at the vaporizer;
a solid/gas separator connected to the reactor so as to separate the solid phase UO₂F₂, manufactured in the reactor, from by-product gas;
a heat exchanger connected to the solid/gas separator so as to allow the by-product gas, supplied from the solid/gas separator, to pass therethrough and be condensed into liquid;
and a liquid/gas separator configured to separate the hydrogen fluoride liquid, condensed at the heat exchanger, from the gas.

5. The treatment apparatus of claim 4, further comprising at least one gas phase distributor provided at the inside of the reactor for uniformly supplying the gas.

6. The treatment apparatus of claim 4, wherein, at least one of an inert gas and superheated steam is supplied in order to manufacture the solid phase UO₂F₂ in the reactor.

7. The treatment apparatus of claim 4, further comprising a fan provided by being connected to a side above the liquid/gas separator and configured to discharge at least a portion of the gas generated inside the liquid/gas separator.

8. The treatment apparatus of claim 4, wherein flow velocity inside the reactor is controlled to be higher than minimum fluidization velocity of UO₂F₂ powder.

9. The treatment apparatus of claim 4, wherein flow velocity inside the solid/gas separator is controlled to be lower than minimum fluidization velocity of UO₂F₂ powder.
